(19) United States
(12) Patent Application Publication
(10) Pub. No.: US 2006/0098551 A1
(43) Pub. Date: May 11, 2006

(54) Optical comparator and method to compare biometric information

(76) Inventors: John F. Carver, Palm City, FL (US); George William McClurg, Jensen Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/208,851

(22) Filed: Aug. 23, 2005

Related U.S. Application Data
(60) Provisional application No. 60/603,282, filed on Aug. 23, 2004.

(51) Int. Cl. G11B 7/00

(52) U.S. Cl. 369/103

(57) ABSTRACT

This invention relates to an apparatus for optically comparing data stored in a holographic medium with data stored in a holographic database. The apparatus includes a beam emitter and a holographic database. The beam emitter emits a reference beam onto the holographic medium and projects a holographic image that corresponds to the data stored in the holographic medium. The holographic database is configured to receive the projected holographic image and to compare it with holographic image data contained in the holographic database. When a match is found or when all of the objects' holographic images on the database have been compared, the database emits a result signal.

### CROSS REFERENCE TO RELATED APPLICATIONS

This application claims the benefit of U.S. Provisional Application No. 60/603,282 filed Aug. 23, 2004, which is incorporated herein by reference in its entirety.

### BACKGROUND OF THE INVENTION

The ability to biometrically cross reference and identify people against a biometric profiling database is urgently important in light of today's security situation. Security screening is often necessary to restrict a person's access to buildings, computer networks, airports, and ports of entry. However, current biometric identification methods are slow because the data retrieval and processing steps are slow.

A biometric database containing fingerprint and facial pattern data typically requires a large amount of data storage space because of the nature of the data and the numbers of data objects stored in such a database. A large and comprehensive biometric database may have several hundreds of gigabytes or even terabytes of data. The sheer size of the database makes the data retrieval and the data processing steps slower and unpractical for certain applications such as airports and other mass transit entry points screening. Slow data retrieval is largely due to how data in conventional magnetic and optical storage media are stored and read.

Conventionally, data are stored as individual bits by distinctive magnetic or optical signature on the surface of the storage medium. Data are also read as individual bits by moving mechanical actuators. As such, the speed in which data can be retrieved is generally limited by the speed in which these actuators can be moved, which is typically constrained by their inertia. One way to circumvent this problem is to use a holographic database.

Holographic data storage offers many advantages over conventional magnetic and optical data storage systems. Instead of storing data as individual bits, holographic data storage stores data in volume. This means data is stored and read an entire page or image at a time.

A holographic storage medium stores data volumetrically, not just on the surface of the medium. In this way, much more data can be stored on a disk than with a magnetic or conventional optic disk. Holographic data are stored as optical interference patterns in the volume of the storage medium. The interference patterns are produced and stored by two beams of coherent light, an object beam (the data-containing beam) and a reference beam. The stored data are then read by projecting the same reference beam onto the storage medium. When a holographic storage medium is exposed to the same reference beam that is used to create the holographic data, the entire image or page of information is instantly reproduced. Unlike conventional magnetic drives and optical drives, actuators are not needed as data are read using lights, and information is not read bit by bit. As such, a holographic data system can be much faster than conventional magnetic and optical data systems because data are read in parallel, not in serial stream.

Accordingly, there is a need for a biometric identification system that uses holographic data to create, store, and match the biometric information of a person.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an example of an optical identification (ID) card verification system according to an embodiment of the present invention.

FIG. 2 illustrates an example system for performing an optical comparison of a live fingerprint according to an embodiment of the present invention.

FIG. 3 illustrates an example system for performing an optical comparison of a facial image using an optical comparator.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

An embodiment of the present invention is now described. While specific methods and configurations are discussed, it should be understood that this is done for illustration purposes only. A person skilled in the art will recognize that other configurations and procedures may be used without departing from the spirit and scope of the invention.

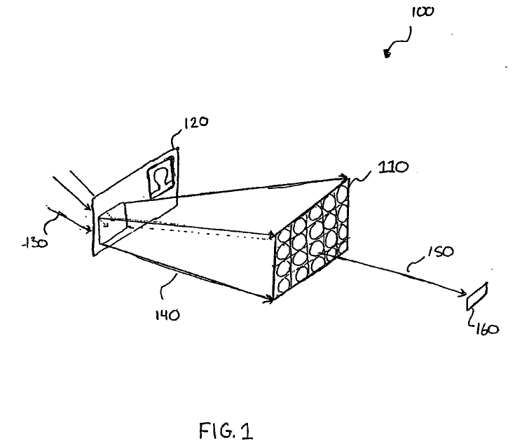

FIG. 1 illustrates an example system for creating an optical comparator 100 for verifying holographic data contained in an identification (ID) card 120 with stored holographic information in a database. Optical comparator 100 includes a beam projector (not shown) that projects a reference beam 130, a sensor 160, and a holographic database 110.

Reference beam 130 is projected onto ID card 120 to intercept the holographic storage material on ID card 120. In this way, an object beam 140 is reconstructed. The reconstructed object beam 140 contains holographic information of the original object used to create the holographic data contained in ID card 120. For example, ID card 120 may contain holographic information of a fingerprint. Once the fingerprint image is reproduced in the form of the reconstructed object beam 140, the information contained therein can be compared with holographic data stored in the holographic database 110. For example, holographic database 110 may store holographic data for one or more fingerprints. This holographic data can be any set of fingerprints desired to be used for comparison. For example, holographic data can be a set of enrolled holographic fingerprint images or patterns, or other populations or groups as desired. When the holographic fingerprint data stored in the holographic storage material of ID card 120 significantly matches holographic fingerprint data stored in holographic database 120, a search result beam 150 is generated. Search result beam 150 excites a sensor 160 to indicate that a match has occurred.

In an embodiment, object beam 140 is moved with respect to holographic database 110 as holographic fingerprint data contained in object beam 140 is optically compared to holographic fingerprint data contained holographic database 110. In an alternative embodiment, holographic database 110 is moved while object beam 140 remains stationary. In still another embodiment, both holographic database 110 and object beam 140 may be moved during the holographic fingerprint data comparison process.

A processor or controller (not shown) can be coupled to database 110 and sensor 160 to further analyze signals output from sensor 160 (such as electrical signals output by sensor 160) and to control operation of database 120. For example, a processor can analyze when a match result has been detected by sensor 160, a time period for comparison has expired, all desired information has been compared, or other condition is met. A processor can further generate desired indications or control signals for output and display.

Although ID card 120 is described to contain biometric data such as a fingerprint, other biometric data could also be used such as iris and facial patterns. In an embodiment, the reference beam 130 comes from coherent light source such as a laser and is projected onto the ID card 120 at various angles.

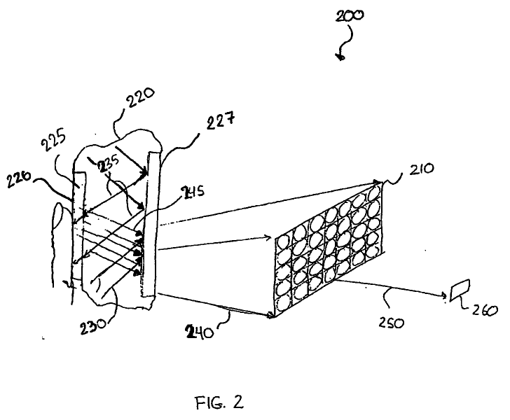

FIG. 2 illustrates an example system 200 for performing an optical comparison of a live fingerprint using an optical comparator according to an embodiment of the present invention. System 200 includes a holographic fingerprint scanner 220, a sensor 260, and a holographic database 210. Holographic fingerprint scanner 220 includes a finger resting plate 225 and an exit plate 227. Resting plate 225 includes a surface 226 upon which a fingerprint can be placed. Fingerprint scanner 220 scans a live fingerprint on surface 226 and generates holographic data 240 of a fingerprint image by using a light beam 235 and reference beam 230. In particular, light beam 235 is projected onto finger resting plate 225 and produces an object beam 245 that contains the fingerprint information. In the fingerprint scanner 220, reference beam 230 is generated and configured to intercept object beam 245 such that holographic data 240 of the live fingerprint is generated. Reference beam 230 may also be applied at various angles.

Further, holographic database 210 is configured to receive holographic data 240 of the fingerprint. Holographic database 210 then compares the received data 240 with stored holographic data. Holographic database 210 may, for example, compare the received data and stored data optically. In an embodiment, object beam 240 is moved to various locations of holographic database 210 that is stationary. In this way, holographic fingerprint data in object beam 240 can be compared with holographic fingerprint data stored in database 210 at a very high rate of speed. In an alternative embodiment, holographic database 210 is moved while object beam 240 remains stationary. In still another embodiment, both holographic database 210 and object beam 240 are moved during the holographic fingerprint data comparison process. Once a significant match is found or once database 210 has searched through all of its archive, a result signal 250 is produced. Additionally, system 200 includes a sensor 260 that is configured to receive the result signal 250. The sensor 260 can be configured to indicate whether a match is found or not based on result signal 250.

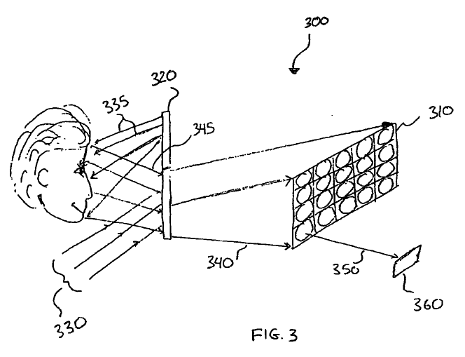

FIG. 3 illustrates an example system 300 similar to system 200. In system 300, a face can be imaged and optically compared to holographic facial data stored in a holographic facial database 310. When there is a match or when the system has searched through the entire database, a search result beam 350 is generated. System 300 includes a face scanner 320, a sensor 360 and a holographic database 310. Scanner 320 produces a light 335 to illuminate the subject's face. In this manner, an object beam 345 that contains the facial information is produced. Further, reference beam 330 is applied in order to generate holographic data 340. In system 300, holographic database 310 is configured to receive holographic data 340. Holographic database 310 compares stored holographic facial data with the received holographic data 340. For example, holographic facial data in holographic database 310 is individually and optically compared with received holographic data 340. In an embodiment, holographic data 340 is configured to move across holographic database 310 and compare all stored holographic facial data. In an alternative embodiment, holographic database 310 is moved while holographic data beam 340 remains stationary. Once a match is found or the entire archive has been searched, a result beam 350 is produced.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

We claim:

1. An apparatus for optically comparing data stored in a holographic medium with data stored in a holographic database, the apparatus comprising:
a beam emitter that emits a reference beam onto the holographic medium and projects a holographic image that corresponds to the data stored in the holographic medium; and
a holographic database containing holographic image data of a plurality of objects,
wherein the holographic database is configured to receive the projected holographic image and to compare it with one of the plurality of objects' holographic image data contained in the holographic database, and wherein the database is further configured to emit a result signal when a match is found.

2. The apparatus of claim 1, further comprising:
a sensor configured to receive the result signal.

3. The apparatus of claim 1, wherein the reference beam intercepts the holographic medium at various angles.

4. The apparatus of claim 1, wherein the sensor further generates an electrical signal when a match is found.

5. An apparatus for optically comparing data stored in a holographic medium with data stored in a holographic database, the apparatus comprising:
a sensor;
a beam emitter that emits a reference beam onto the holographic medium and projects a holographic image that corresponds to the data stored in the holographic medium; and
a holographic database configured to receive the projected holographic image;
wherein the holographic database is capable of matching the projected holographic image with one of a plurality of holographic images stored in the database, and wherein the holographic database is capable of emitting a result signal to the sensor when a match is found.

6. An optical comparator comprising:
a scanner configured to scan an item and produce a holographic image of the item;
a holographic database configured to receive the item's holographic image data, the holographic database contains holographic image data of a plurality of objects,
wherein the holographic database is configured to compare the item's holographic image data with the holographic data of the plurality of objects stored in the database, the holographic database is configured to emit a result signal when a match is found.

7. The optical comparator of claim 6, further comprising:
a sensor that is configured to detect the result signal.

8. An optical comparator comprising:
a holographic scanner having a scanning area, the scanner is configured to scan an object placed within the area and produce a holographic image of the object;
a holographic database that is configured to receive the produced holographic image and to compare it with one of a plurality holographic images stored in the holographic database, the database is configured to produce a result signal when a match is found.

9. A method for comparing optical data comprising:
generating a holographic image data of an object;
projecting the holographic image data of the object onto a holographic database;
comparing the holographic image data with holographic data stored in the holographic database; and
emitting a result signal when a match is found.
